(19) United States
(12) Patent Application Publication
(10) Pub. No.: US 2007/0279467 A1
(43) Pub. Date: Dec. 6, 2007

(54) Ink jet printing system for high speed/high quality printing

(76) Inventors: Michael Thomas Regan, Rochester, NY (US); Mary Christine Brick, Webster, NY (US); Daniel Gelbart, Vancouver (CA); Gregory James Garbacz, Rochester, NY (US); Paul D. Yacobucci, Rochester, NY (US)

Correspondence Address: Mark G. Bocchetti;Patent Legal Staff, Eastman Kodak Company, 343 State Street, Rochester, NY, 14650-2201, US

(21) Appl. No.: 11/445,566

(22) Filed: Jun. 2, 2006

(51) Int. Cl. G01D 11/00

(52) U.S. Cl. 347/100

(57) ABSTRACT

In an ink jet printing apparatus for high speed/high quality printing, an ink jet ink having a high concentration of solids the range of about 20-70 wt. %, and exhibiting shear-thinning characteristics.

### FIELD OF THE INVENTION

This invention relates in general to image printing in an apparatus including an ink jet printing device, and more particularly to ink jet printing for high speed/high quality printing utilizing high solids shear-thinning inks in ink jet printhead devices.

### BACKGROUND OF THE INVENTION

High-resolution digital input imaging processes are desirable for superior quality printing applications, especially high quality color printing applications. As is well known, such processes may include electrophotographic processes using small particle dry toners, e.g., having particle diameters less than about 7 micrometers, electrostatographic processes using non-aqueous, solvent based liquid developers (also referred to as liquid toners) in which the particle size is typically on the order of 1 micrometer or less, and ink jet processes. Ink jet recording systems employ either aqueous inks using water as the main liquid carrier where the drying involves absorption, penetration, and evaporation; oil based inks where non-volatile oils are the main liquid carrier and the drying involves absorption and penetration; solvent based inks where volatile solvents are the main liquid carrier and the drying involves primarily evaporation; ultra-violet (UV) curable inks in which the drying is replaced by polymerization if the ink is 100% solids; and hot melt or phase change inks, in which the drying is replaced by solidification.

Exemplary art pertaining to aqueous pigmented based inks includes U.S. Pat. Nos. 6,143,807 and 6,153,000. Exemplary art pertaining to dye-based ink jet inks is disclosed in U.S. Publication No. 2003/0209166. Pigmented solvent based inks for use in ink jet apparatus are disclosed in U.S. Pat. Nos. 6,053,438 and 6,166,105. Solvent based ink jet technology has an advantage over aqueous based ink jet technology in that an image formed on a receiver member requires relatively little drying energy and therefore dries rapidly, exhibits less paper deformation upon printing, and gives superior image quality on a wide variety of receivers and has superior resistance to water. Many oil-based inks for use in ink jet recording have in common the use of a non-polar organic carrier fluid, such as an aliphatic hydrocarbon, alicyclic hydrocarbon, or aromatic hydrocarbon. An ink with a non-polar solvent is advantageous as inks for high-speed ink jet printers in that it is less apt to cause clogging of the nozzle and requires less frequent cleaning during printing. Oil based ink jet inks and printing methods with non-polar solvents are disclosed in U.S. Pat. Nos. 6,245,139; 5,453,121; 6,126,274; and 6,133,341. However, inks having only non-volatile polar oils as the liquid carrier can give rise to a problem that the solvent remains on the printings for a long time, and the residual solvent is apt to cause “strike-through”, where the ink can be seen through from the back side of the print, and/or smearing. The problem of strike-through or smear may be avoided by formulating an ink with mixtures of volatile and non-volatile organic solvents, as disclosed in U.S. Publication Nos. 2003/0192453 and 2004/0227799. UV curable ink formulations typically contain polymerizable oligomers, stabilizers, photoinitiators, colorants, and other ink jet components that form a permanent image upon irradiation with UV light. UV curable ink compositions may contain up to 100% solids. In UV curable inks containing 100% solids, drying is replaced by polymerization upon irradiation with UV light. Exemplary art pertaining to UV curable ink jet inks and printing methods are disclosed in U.S. Pat. Nos. 5,623,001; 6,135,654; 6,454,405; 6,457,823; and U.S. Publication Nos. 2002/0198289; 2003/0164870; 2004/0006157. Ink jet technology may be used to deposit fluid materials on receivers and has numerous applications, mainly in printing. Ink jet printers function by depositing small droplets of fluid at desired positions on a receiver. There are various ink jet printing technologies.

Digital ink jet processes have the inherent potential to be simpler, less costly, and more reliable than digital electrophotographic processes. Generally, it is usual for ink to be fed through a nozzle, the diameter of which nozzle being a major factor in determining the droplet size and hence the image resolution on a recording surface. There are two major classes of ink jet printing; namely, continuous ink jet (CIJ) printing, and drop-on-demand (DOD) ink jet printing. Continuous ink jet printing utilizes the nozzle to produce a continuous stream of electrically charged droplets, some of which droplets are selectively delivered to the recording surface to force a desired image, and the remainder being electrostatically deflected and collected in a sump for reuse. Alternatively, the image printing drops can be selected by other methods such as air deflection and thermal steering. CIJ printing methods and devices are disclosed in U.S. Pat. Nos. 6,412,910; 6,457,807; 6,508,532; 6,505,921; 6,517,197; 6,536,883; 6,554,389; 6,554,410; 6,561,616; 6,572,222; 6,572,223; 6,578,955; 6,588,888; 6,588,889; 6,588,890; 6,592,201; 6,682,182; 6,739,705; 6,827,429; 6,863,385; 6,883,904; 6,943,037; and 6,986,566.

Drop-on-demand ink jet printing produces drops from a small nozzle only as required to generate an image, the drops being produced and ejected from the nozzle by local pressure or temperature changes in the liquid in the immediate vicinity of the nozzle, e.g., using a piezoelectric device, an acoustic device, or a thermal process controlled in accordance with digital data signals. In order to produce a gray scale image, variable numbers of drops are delivered to each imaging pixel. Typically, an ink jet head of an ink jet device includes a plurality of nozzles. In most commercial ink jet systems, aqueous based inks containing dye colorants in relatively low concentrations are used. As a result, high image densities are difficult to achieve, image drying is not trivial, and images are not archival because many dyes are disadvantageously subject to fading. Moreover, the quality of aqueous based ink jet image is strongly dependent upon the properties of the recording surface, and will for example, be quite different on a porous paper surface than on a smooth plastic receiver surface. By contrast, the quality of an electrophotographic toner image is relatively insensitive to the recording surface, and the toner colorants in both dry and liquid electrophotographic developers are generally finely divided or comminuted pigments that are stable against fading and able to give high image densities.

To overcome problems associated with fading and low image densities associated with dyed aqueous based inks, pigmented aqueous based inks have been disclosed in which a pigmented material is colloidally dispersed.

Typically, a relatively high concentration of pigmented material is required to produce the desired highest image densities (Dₘₐₓ). Exemplary art pertaining to pigmented aqueous based inks includes U.S. Pat. Nos. 6,143,807 and 6,153,000 as mentioned earlier. Generally, pigmented inks have a much greater propensity to clog or modify the jet(s) opening of a drop-on-demand type ink jet head than do dyed inks, especially for the narrow diameter jets required for high resolution drop-on demand ink jet imaging, e.g., at 600 dots per inch. Drop-on-demand printers do not have a continuous high pressure in the nozzle, and modification of the nozzle behavior by deposition of pigment particles is strongly dependent on local conditions in the nozzle. In continuous ink jet printers using pigmented inks, the relatively high concentrations of pigment typically affects the droplet break-up, which tends to result in non-uniform printing.

A deficiency associated with most high resolution conventional ink jet devices that deposit ink directly on to a (porous) paper receiver is an unavoidable tendency for image spreading, with a concomitant resulting degradation of resolution and sharpness of the image produced. As a drop of deposited liquid ink is absorbed, capillary forces tend to draw the ink along the receiver surface and into the micro-channels between paper fibers, thereby causing a loss of resolution. Inasmuch as the colorant concentration of a dyed aqueous-based ink tends to be low, there is a comparatively large proportion of liquid vehicle, which must be absorbed from each drop. This also holds true for the case of pigmented aqueous based inks, for which particle sizes may be sub-micron; i.e., such very small particles can be swept along by the carrier liquid as it spreads in the paper receiver, thereby compromising high resolution imaging quality. In addition to capillary spreading by liquid absorption in a receiver, spreading may also be a problem if the carrier liquid is not readily absorbed by a receiver; e.g., if the receiver is a coated specialty paper used in a high resolution conventional ink jet device that deposits ink directly on to a receiver. The spreading is strongly dependent upon the surface energy of the coating on the paper receiver and the surface tension of the ink. Unusual particle size distributions such as disclosed in the above-cited U.S. Pat. No. 6,143,807, may be useful with pigmented aqueous based inks, perhaps to mitigate the effects of image spread. Another limitation of ink jet printing is that the image density tends to be low. This arises from two sources. First, to facilitate drying and minimize spreading along the surface, porous paper receivers must be used. As the ink is absorbed into the paper, the paper fibers show through the ink, thereby limiting the density. Second, in order to jet ink, the viscosity must be low. The low viscosity limits the amount of colorant that can be present, thereby limiting the image density that can be obtained.

A limitation of printing at high speed with ink jet technology arises from the amount of liquid used in ink jet printing. Ink jet inks typically have a low concentration of colorant, predicated by the ability to maintain the low viscosity required for jetting through an ink jet printhead. Thus, the image on the receiver has relatively large amounts of ink, which need to be dried before the image is usable. At high speeds, this drying step is complex and energy-intensive.

Ink jet printing currently cannot generally achieve printing quality as high as can be achieved using offset printing techniques, especially at high speeds. Ink jet printing is typically slower than traditional offset printing. This is especially true for process color printing. For example, the linear printing speed of ink jet printing is typically of the order of 10 times slower than can be achieved in offset printing. This represents a major issue limiting the implementation of ink jet technology in industrial printing systems. The ink jet printing speed limit is dictated by the rate at which ink jet nozzles can eject ink in discrete controllable amounts. This rate is at present on the order of 20,000 pulses per second for DOD ink jet printers to print rates on the order of 2 pages per second. Continuous ink jet printing can be performed more quickly. However, at high speeds, the results tend to be poor due to the difficulties mentioned above.

Print quality of ink jet printers is also reduced by “wicking” or “running”. The low-viscosity inks typically employed in ink jet printers tend to “run” along the fibers of certain grades of paper receivers. This phenomenon is also referred to as “wicking” and leads to reduced quality printing, particularly on the grades of paper desirable in high volume printing. Wicking can cause printed dots to become much larger than the droplet of ink emerging from the ink jet nozzle. Wicking can also reduce the brightness of the image, as some of the colorant in the image gets wicked below the receiver surface, thus not contributing adequately to image brightness. Wicking also reduces the maximum image density because the paper fibers of the receiver show through.

It is possible to reduce wicking by printing on specially treated paper receivers. However, such paper tends to be undesirably expensive. Furthermore, in order to produce prints that resemble photographic prints, a type of receiver that is commonly used has a polymer layer to mimic the resin-coated photographic paper. As polymers do not absorb water or the carrier fluid of ink, the polymer layer has to incorporate voids or channels to “absorb” the relatively large amount of ink in a typically high-coverage pictorial image, which increases the cost and complexity of the receivers.

Although ink jet technology is successful in certain applications, it has limitations that prevent it from being fully utilizable for a wide variety of applications as a digital press. First, ink jet inks need to have relatively low viscosity, typically less than 10 mPa-s and more typically less than 5 mPa-s, to allow them to be successfully jetted. In addition, ink jet inks typically have fairly low surface tensions, typically less than approximately 35 dynes/cm. These properties would cause them to run, thereby losing resolution and image quality, unless the paper receivers onto which they are jetted, absorbs them rapidly.

The requirement that the ink jet solvent be rapidly absorbed into the receiver imposes further constraints on ink jet printing. First, the need for the receiver to absorb the ink restricts the types of receivers that can be used. For example, high quality graphic art papers such as various clay-coated papers would not absorb such ink, resulting in ink running. Moreover, the absorption of the ink into the paper causes the maximum image density to be too low for acceptability in most printing applications.

An additional problem with using ink jet technology for digital printing press applications is that, in order to jet the ink, the ink must be diluted to a level so that its viscosity is low enough to allow jetting. This introduces far more liquid into the ink than is present in traditional printing. That amount of liquid, can cockle the paper receiver, and also decrease the density of the printed image. In addition, because of the low viscosity needed to be able to jetsinks, there is a large quantity of liquid present in jettable inks. This liquid must be removed, generally by evaporation. When liquid is water, water removal is energy intensive; and when the liquid is a solvent, removal produces large quantities of solvent vapors that must be recovered and handled properly. Such liquid removal concerns must be addressed if ink jet technology were to be applied to high volume, high speed digital printing presses.

Gravure printing is a well-known commercial process in which gravure ink is applied to a plate or roller, including a multitude of individual cells corresponding to the desired printed image. In this process, ink is applied via an applicator that typically has a doctor blade. The receiver is then pressed against the inked image and some of the ink, typically about 60% in each cell, is transferred to the receiver. An electrostatic field may be applied across the transfer nip to enhance transfer. In order for a gravure ink to uniformly coat a gravure roller or plate (hereafler referred to as a gravure roller or gravure cylinder, with the understanding that either term is inclusive of a gravure plate), the viscosity of a gravure ink ranges from roughly 50 to 1,000 mPa-s measured under low shear conditions.

Printing high pictorial content images at high speeds presents difficult challenges in that the amount of water that is presented to the receiver is excessive and the drying time available is short. As a result, the image quality achievable is poor due to the artifacts such as coalescence, inter-color bleed, paper cockle, etc. It is known that as the percent of solids increases, the viscosity increases. The relationship is such that the change in viscosity in the range of typical ink jet inks (2%-10% solids) is less abrupt than for aqueous gravure inks (25%-40% solids). As a result, the drying rate for gravure inks is faster and thus preferred for high-speed printing. Typical gravure presses operate at 1,000-3,000 ft./min. These inks are typically not jettable because the viscosity is too high to support droplet formation from the ink jet nozzle.

Thus, there remains a need for a simpler method of using ink jet printing to form high quality color images on a wide range of receivers, without the aforementioned limitations of prior art. In addition, there is a need for ink jet printing methods that provide combinations of print quality, speed, and cost which improve on the prior art.

### SUMMARY OF THE INVENTION

According to this invention, certain high-solids inks that exhibit shear-thinning behavior have been unexpectedly found to be jettable from an ink jet printhead. In view of this phenomenon, an object of this invention is to provide a novel ink composition for printing through ink jet printheads. This invention could be applied to an ink jet printing through a continuous ink jet head or a drop-on-demand printhead if the ink is maintained in a shear-thinning state. The invention, and its objects and advantages, will become more apparent in the detailed description of the preferred embodiments presented below.

### BRIEF DESCRIPTION OF THE DRAWINGS

In the detailed description of the preferred embodiments of the invention presented below, reference is made to the accompanying drawings, in which:

FIG. 1 is a graphical representation of viscosity versus shear rate of a high-solids ink for printing according to this invention;

FIG. 2 is a graphical representation with the power law slopes for different n values;

FIG. 3 shows a graphical representation where a fluid at 200 mPa-s at 0.1/s starts shear-thinning at 0.1/s;

FIG. 4 is a schematic cross-sectional view of a continuous ink jet printing apparatus nozzle in which an ink according to this invention is used;

FIG. 5 is a schematic view of a wiring diagram for the continuous ink jet apparatus nozzles in which an ink according to this invention is used;

FIG. 6 is a graphical representation of the shear-thinning behavior at two temperatures of an ink according this invention;

FIG. 7 is a photomicrograph of drop formation in a jet formed at an operating pressure of 65 psi, 50 kHz, and 6.7 μs pulse;

FIG. 8 is a photomicrograph of drop formation of 2 jets formed at an operating pressure of 65 psi, 150 kHz, and 2.7 μs pulse;

FIG. 9 is a photomicrograph of drop formation of 2 jets formed at an operating pressure of 65 psi, 200 kHz, and 1.6 μs pulse;

FIG. 10 is a simplified block schematic diagram of one exemplary printing system in which an apparatus and ink according to this invention is used;

FIG. 11 is a schematic cross-sectional view of a continuous ink jet printing apparatus nozzle in which an ink according to this invention is used;

FIG. 12 is a schematic view of a printhead for the continuous ink jet apparatus nozzles in which an ink according to this invention is used;

FIG. 13 is an example of droplets produced by electrically activated waveforms for the continuous ink jet apparatus nozzles in which an ink according to this invention is used; and

FIG. 14 is a schematic view of a continuous ink jet printer apparatus in which an ink according to this invention is used.

### DETAILED DESCRIPTION OF THE INVENTION

As noted above, ink jet printing suffers from certain limitations due to image spreading and excess liquid contents. This is substantially due to the requirement that the ink be of low enough viscosity to prevent clogging of the ink jet nozzles. It has been discovered that a certain category of inks has a high viscosity (i.e., low liquid level), but is capable of being used successfully in ink jet apparatus to take advantage of ink jet apparatus operational characteristics. Such inks for high speed/high quality printing are high solid concentration inks and exhibit shear-thinning behavior. A shear-thinning fluid is one in which the measured viscosity decreases with increasing shear rate.

It has been unexpectedly found that certain high-solids inks that exhibit shear-thinning behavior are jettable from an ink jet printhead. In view of this phenomenon, this invention is directed to ink jet printing with certain high-solids shear-thinning inks through a continuous ink jet printhead. Additionally this invention could be applied to ink jet printing through a drop-on-demand printhead if the ink is maintained in a shear-thinning state. Maintaining the shear-thinning state may be accomplished by mechanical methods. Examples of methods of agitation to maintain a shear-thinning state may include continuous ink circulation through the drop-on-demand head manifold and ultrasonic agitation of the ink in the drop on demand head manifold. This is necessary to provide the low ink viscosity required for drop ejection and fast chamber refill to support high printing speeds. Shear-thinning refers to a decrease in fluid viscosity as a fluid flows in response to an external stimuli, such as; an imposed volumetric flow rate or an applied pressure head.

Viscosity describes a material's resistance to flow; specifically it is defined as the ratio of the stress to the strain rate. In the laminar flow of fluid through a pipe or slot, the viscosity is related to the pressure drop across the bounding volume divided by the volumetric flow rate. It is useful to distinguish between fluids whose viscosity is independent of strain rate (Newtonian), and those that exhibit a viscosity that varies with strain rate (non-Newtonian). For shear deformations, the strain rate is often referred to as the shear rate and thus non-Newtonian fluids whose viscosity decreases as the shear rate increases are termed as shear-thinning fluids. Standard rheology and fluid dynamics text books, such as R. L. Mott, Applied Fluid Mechanics, (2^{nd} Edition, Charles E. Merrill Company, Columbus, Ohio, 1972) or C. W. Macosko, Rheology, (1^{st} Edition, Wiley-VCH, New York, 1994), detail how viscosity is related to stress and strain under different deformation conditions in shear and extension.

The phenomenon of shear-thinning is complex and manifests itself differently for different materials. Some fluids exhibit a viscosity plateau at low shear rates, followed by a region of viscosity decrease and then another plateau at high shear rates. Other materials shear thin continuously at low and moderate rates and reach a plateau at high shear rates, often termed the second Newtonian plateau. The details of the specific rheological response depend on the constituents of the fluids and their interactions.

Mathematically, these effects may be captured with an expression such as the Cross model (see Macosko, page 86):

$$η ( \dot{γ} ) = {( {η}_{o} - {η}_{∞} ) [ 1 + {( \frac{\dot{γ}}{{\dot{γ}}_{c}} )}^{1 - n} ]}^{- 1} + {η}_{∞} \qquad ( 1 )$$

where η is the viscosity, at a shear rate \dot{γ}, ηₒ is the viscosity at the low shear rate plateau, η_{∞} is the viscosity at the higher shear rate plateau, \dot{γ}_{c} is the shear rate at the onset of shear-thinning, and the power law index n is the slope of the shear-thinning response. In the case where there is no observable low viscosity plateau, an expression of the following form is useful:

$$η ( \dot{γ} ) = {η}_{∞} [ {( \frac{\dot{γ}}{{\dot{γ}}_{o}} )}^{n - 1} + 1 ] \qquad ( 2 )$$

where \dot{γ}ₒ is a material dependent shear rate and the other symbols have the same meaning as defined immediately above.

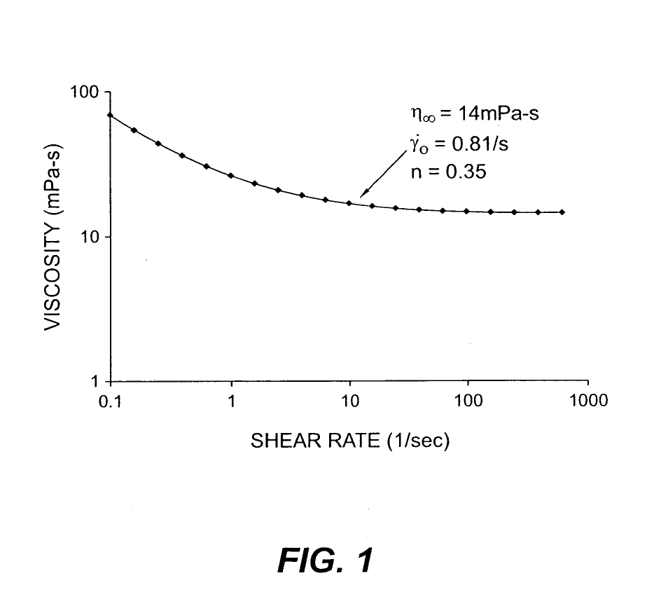

Using equation (2), the shear-thinning properties of high solids inks may be represented as shown for the ink in FIG. 1.

The specific parameter values describing the ink rheology are:

η_{∞}=14 mPa-s

\dot{γ}ₒ=0.81/s

n=0.35

(n−1)=−0.65

### The slope in the shear-thinning region is (n−1); thus the slope in the shear-thinning region for this ink is (n−1)=−0.65.

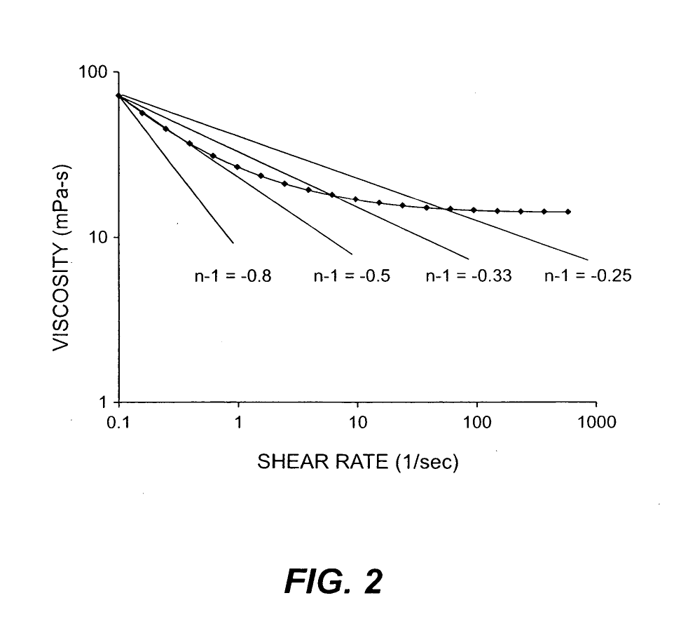

Mathematically, one can calculate the slope ranges required to meet shear-thinning target lines representing the power law slopes for different n values are shown in FIG. 2. From this FIG., it is observed that the viscosity decreases the most at the lowest shear rates. Therefore, the value of (n−1) for a shear-thinning fluid, is the slope of the fluid at the lowest shear rate using power law equation (2).

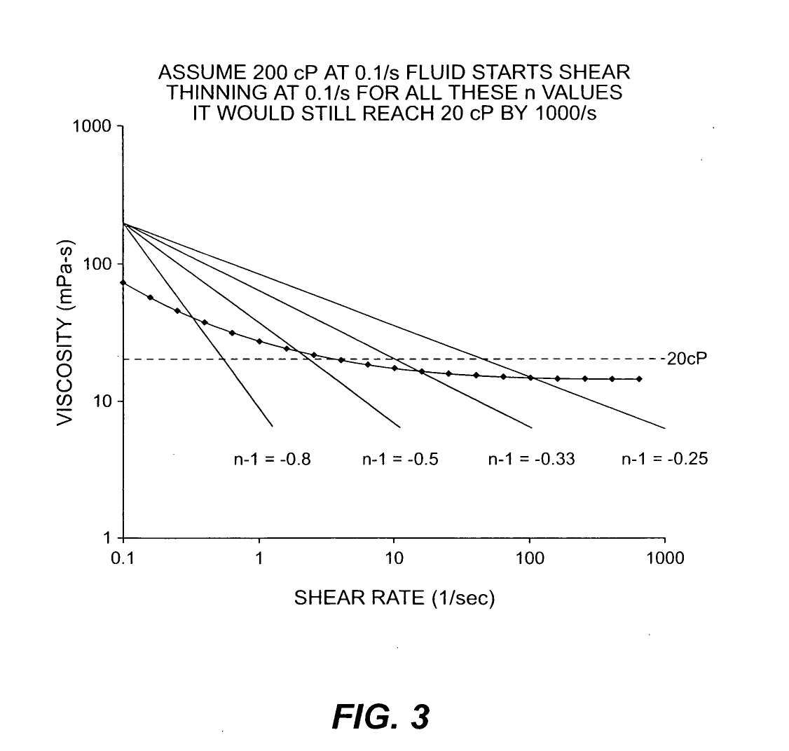

According to the fluids in this invention, the onset of shear-thinning occurs when the viscosity is within the range of 1 to 40 mPa-s at 1,000/s. The limiting cases are n=0 for plug flow when (n−1)=−1 and n=1 for Newtonian flow when (n−1)=0. FIG. 3 shows some theoretical viscosity profiles of a shear-thinning fluid with a viscosity of 200 mPa-s at 0.1/s at (n−1) slopes between −0.8 and −0.25, compared to the fluid shown in FIG. 1. For the theoretical values of (n−1) between −0.8 and −0.25, the fluid will have a viscosity of 20 mPa-s, at shear rates below 1,000/s.

For proper jettability and drop breakup in a printer, the viscosity must be within a certain range, typically less than 10 mPa-s. The novelty of the present invention is that inks with low shear viscosities much larger than the cutoff dictated by the printing system may be used, if they shear thin into the proper viscosity range under the flow rates encountered during use. The shear-thinning properties of the high solids inks herein allow these materials to achieve this required viscosity condition at shear rates lower than those necessary for robust ink jet printer operation.

### Shear-Thinning Additives:

As known in the art, the shear-thinning behavior of a fluid can arise from particle-particle interactions, particle-liquid interactions, and interactions between soluble molecules in the fluid such as polymers. At low shear rates, the particles or molecules in the fluid associate with each other or other parts of the fluid and form a random network, resulting in a high viscosity. At higher shear rates, the shear field causes the particles or fluid molecules to disassociate and align or elongate in the direction of shear, resulting in a low viscosity.

Useful shear-thinning inks for jetting in this invention have a concentration in the range of about 20-70 wt. % solids, a viscosity between 50 and 200 mPa-s at a shear rate of about 0.1/s, and a viscosity less than 20 mPa-s at a shear rate of about 1,000/s. Preferably, the shear-thinning inks have a concentration in the range of about 30-40 wt. % solids, a viscosity between 60 and 100 mPa-s at a shear rate of about 0.1/s, and a viscosity less than 10 mPa-s at a shear rate of about 1,000/s. The following example of some shear-thinning additives is not exhaustive or meant to exclude other shear-thinning fluids that might be suitable for the ink according to this invention.

Typical examples of shear-thinning additives suitable in an ink are also particles such as organic and inorganic pigments and dyes, clays such as bentonite, hectorite, and montmorillonite, clays modified with ionic organic groups, and water-dispersible polymers.

In applications where pigments are used as the colorant in the ink, any known pigment, or combination of pigments, commonly used in an ink composition having an aqueous or non-aqueous, or solvent based carrier can be used. The pigments can be stabilized by a dispersant; for example, those pigments disclosed in U.S. Pat. Nos. 5,026,427; 5,086,698; 5,141,556; 5,160,370; and 5,169,436 for aqueous inks; and U.S. Pat. Nos. 6,053,438; 6,133,341; 6,166,105; and U.S. Publication Nos. 2003/0192453 and 2004/0227799; for solvent based inks. Additionally, they can be either self-dispersible pigment, such as those described in U.S. Pat. No. 5,630,868, or encapsulated pigments. The exact choice of pigments will depend upon the specific application and performance requirements, such as color reproduction and image stability. Pigments suitable for use include, for example: azo pigments, monoazo pigments, diazo pigments, azo pigment lakes, β-Naphthol pigments, Naphthol AS pigments, benzimidazolone pigments, diazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black. Typical examples of pigments, which may be used include: Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Violet 1, 2, 3, 5:1, 13, 19, 23, 25, 27, 29, 31, 32, 37, 39, 42, 44, 50; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66; C.I. Pigment Green 1, 2, 4, 7, 8, 10, 36, 45; C.I. Pigment Black 1, 7, 20, 31, 32; and C.I. Pigment Brown 1, 5, 22, 23, 25, 38, 41, 42. In one embodiment, the pigment is C.I. Pigment Blue 15:3, C.I. Pigment Red 122, C.I. Pigment Yellow 155, C.I. Pigment Yellow 74, bis(phthalocyanylalumino)tetraphenyldisiloxane or C.I. Pigment Black 7.

When a pigment dispersant is added to the ink composition, the pigment dispersant(s) can include water-soluble resins, surface-active agents, and the like. Examples of water-soluble resins include natural resins, semi-synthetic resins, synthetic resins, etc. Examples of synthetic resins include alkali-water-soluble resins such as polyacrylic acid resins, polymaleic acid resins, styrene-acrylic acid co-polymers and styrene-maleic acid co-polymers, water-soluble styrene resins, polyvinyl pyrrolidone, polyvinyl alcohol, water-soluble urethane resins, etc. Examples of surface-active agents include anionic surface-active agents, cationic surface-active agents, non-ionic surface-active agents, ampholytic surface-active agents, etc.

In the case of organic pigments, the ink may contain up to approximately 20% pigment by weight, but will generally be in the range of approximately 0.1 to 10%, preferably approximately 0.1 to 5%, by weight of the total ink composition for most ink jet printing applications. If an inorganic pigment is selected, the ink will tend to contain higher weight percentages of pigment than with comparable inks employing organic pigments.

Instead of pigment, dye can also be used as the ink colorant. The dye can be either water-soluble or water-insoluble. The water-insoluble dye can be directly dissolved in the non-aqueous liquid carrier, or dispersed, or encapsulated into water-dispersible particles as disclosed in U.S. Pat. No. 6,867,251. A broad range of water-insoluble dyes may be used such as an oil dye, a disperse dye, or a solvent dye, such as Ciba-Geigy Orasol Red G, Ciba-Geigy Orasol Blue GN, Ciba-Geigy Orasol Pink, and Ciba-Geigy Orasol Yellow. Preferred water-insoluble dyes can be xanthene dyes, methine dyes, polymethine dyes, anthroquinone dyes, merocyanine dyes, azamethine dyes, azine dyes, quinophthalone dyes, thiazine dyes, oxazine dyes, phthalocyanine dyes, mono or poly azo dyes, and metal complex dyes. More preferably, the water-insoluble dyes can be an azo dye such as a water insoluble analog of the pyrazoleazoindole dye disclosed in U.S. Pat. No. 6,468,338, and the arylazoisothiazole dye disclosed in U.S. Pat. No. 4,698,651, or a metal-complex dye, such as the water-insoluble analogues of the dyes described in U.S. Pat. Nos. 5,997,622 and 6,001,161; i.e., a transition metal complex of an 8-heterocyclylazo-5-hydroxyquinoline. The solubility of the water insoluble dye can be less than 1 g/L in water, and more preferably less than 0.5 g/L in water.

The ink jet inks of the invention can be prepared by any process suitable for preparing liquid-carrier based inks. The pigmented ink is prepared by pre-mixing the selected pigment(s) and dispersant in the liquid carrier. In the case of dyes, some of the same factors apply except that there is no dispersant present and no need for pigment de-aggregation. The dye-based ink is prepared in a well-agitated vessel rather than in dispersing equipment. Co-solvents may be present during the dispersion. The dispersing step may be accomplished in a horizontal mini mill, a ball mill, an attritor, or by passing the mixture through a plurality of nozzles within a liquid jet interaction chamber at a liquid pressure of at least 1,000 psi to produce a uniform dispersion of the pigment particles in the liquid carrier medium. The pigment dispersion will also have a small enough particle size so as not to result in clogging of typical commercial ink jet heads or nozzles. A smaller particle size is preferred since this will reduce the chance of forming aggregates that could potentially plug the ink jet printing head or nozzle. Typical pigmented inks of the invention have, a median particle size, less than about 100 nanometers. If the pigment dispersion is made in liquid carrier, it is diluted with the appropriate liquid carrier to obtain the appropriate concentration in the ink jet ink. By dilution, the ink is adjusted to the desired viscosity, color, hue, saturation density, and print area coverage for the particular application.

Typical examples of shear-thinning liquid-dispersible or liquid-soluble polymers include high molecular weight homo-polymers and co-polymers of acrylic acid crosslinked with polyalkenyl polyether sold under the trade name Carbopol®, synthetic hydrophobically-modified acrylate polymers sold under the trade name Acusol®, polyurethane elastomers, homo-polymers, and co-polymers of styrene, α-methylstyrene, 2-ethylhexylacrylate, acrylic or methacrylic acid, polystyrene, high-density polyethylene (HDPE), linear low density polyethylene (LLDPE), polyethylene oxide (PEO), polyvinyl pyrrolidone, polyvinyl acetate, and polyvinyl alcohol. Other examples of shear-thinning fluids known in the art are liquid-soluble or liquid-dispersible polysaccharides, whose structure includes repeating sugar units. Examples of such polysaccharides are xanthan gum and its derivatives, guar gum and its derivatives, hydroxyethylcellulose, carboxymethyl cellulose, and alginic acid salts. Shear-thinning water-dispersible gums or resins can be either natural or synthetic. Natural gums include seaweed extracts, plant exudates, seed or root gums, and microbiologically fermented gums. Synthetic gums, such as modified versions of cellulose or starch, include propylene glycol alginate, carboxymethyl locust bean gum and carboxymethyl guar. The ink compositions useful in this invention are based upon the use of polar solvents (preferably water) that are 50%-95% by weight of the ink. Although water is preferred, other polar solvents may be used in place of up to 50% of the water.

Suitable shear-thinning additives are miscible or dispersible in the polar solvent along with the dispersed pigment particles.

For maximum compatibility with a variety of printing receivers and superior water resistance, solvent based inks can be used. Liquid carriers for solvent-based inks include both non-polar and polar solvents. Examples of non-polar solvents include straight chain or branched chain aliphatic hydrocarbons, alicyclic hydrocarbons, aromatic hydrocarbons, and halogen-substituted products thereof. Specific examples of the solvent carrier liquid include octane, isooctane, decane, isodecane, decalin, nonane, dodecane, isododecane, cyclohexane, cyclooctane, cyclodecane, benzene, toluene, xylene, mesitylene, Isopar E, Isopar G, Isopar H, Isopar L (Isopar: trade name of Exxon Co.), Shellsol 70, Shellsol 71 (Shellsol: trade name of Shell Oil Co.), Amsco OME and Amsco 460 (Amsco: trade name of Spirits Co.), and mixtures thereof. Examples of non-polar solvents include fatty acids, esters, alcohols, and ethers. Examples of fatty acids include isopalmitic acid, oleic acid, and isostearic acid. Examples of esters include methyl laurate, isopropyl laurate, isopropyl myristate, isopropyl palmitate, isostearyl palmitate, methyl oleate, ethyl oleate, isopropyl oleate, butyl oleate, methyl linoleate, isobutyl linoleate, ethyl linoleate, isopropyl isostearate, soybean oil methyl ester, soybean oil isobutyl ester, tall oil methyl ester, tall oil isobutyl ester, diisopropyl adipate, diisopropyl sebacate, diethyl sebacate, propylene glycol monocapric ester, trimethylolpropane tri-2-ethylhexanoic ester, and glycerol tri-2-ethylhexanoic ester. Examples of alcohols include isopalmityl alcohol, isostearyl alcohol, and oleyl alcohol. Examples of ethers include glycol ether-based solvents, such as diethylene glycol monobutyl ether, ethylene glycol monobutyl ether, propylene glycol monobutyl ether, and propylene glycol dibutyl ether.

The ink may form a permanent image upon irradiation of UV light, and contain polymerizable oligomers, stabilizers, photoinitiators, colorants, and other ink jet components that are commonly known in the art for formulating UV curable inks. UV curable urethane resins, acrylic resins, polyester resins, and epoxy resins suitable for use in the invention are known in the art. Examples of suitable UV curable resins include, but are not limited to, those urethane resins described in U.S. Pat. Nos. 5,596,065 and 5,990,192; which are incorporated by reference herein in their entirety, and polyester resins described in U.S. Pat. No. 6,265,461, which is incorporated by reference herein in its entirety. The UV curable ink composition may contain up to 100% solids. The UV curable ink can contain less than 100% solids, in which case the components are dispersed in the liquid carrier. The dispersible UV curable resins will also have a small enough particle size so as not to result in clogging of typical commercial ink jet beads or nozzles. A smaller particle size is preferred since this will reduce the chance of forming aggregates that could potentially plug the ink jet printing head or nozzle. Typical UV curable resins of the invention have a median particle size, less than about 100 nanometers. Curing of the image formed from the ink jet ink composition can be initiated via a source of UV light. That is, while curing can be initiated by naturally occurring UV light, normally, a man-made source of UV is employed; e.g., to crosslink the polymeric matrix.

Agents to control pH may also be included in the ink, if desired. Examples of such pH controlling agents suitable for inks of the present invention include, but are not limited to: acids; bases, including hydroxides of alkali metals such as lithium hydroxide, sodium hydroxide and potassium hydroxide; phosphate salts; carbonate salts; carboxylate salts; sulfite salts; amine salts; amines such as diethanolamine and triethanolamine; and mixtures thereof and the like.

Additionally, the ink may contain additives such as organic solvent material capable of penetrating into the receiver to act as a drying agent, defoamers, corrosion inhibitors, surfactants to tune the surface tension, viscosity modifiers, biocides, sequesterants, and humectants, all commonly known in the art for formulating inks. It is understood that the optimal composition of such an ink is dependent upon the jetting method used and on the nature of the receiver to be printed on.

The ink is applied to a suitable receiver in an image-wise fashion. Application of the ink to the receiver can be by any suitable ink jet process compatible with the ink composition, such as CIJ and DOD ink jet printing as discussed above.

The ink composition of the present invention is suited for printing on a variety of receivers of both absorbing and non-absorbing types. A wide variety of receivers can be used in the practice of the present invention; e.g., papers, fabrics, polymeric films, cellulosic films, glasses, metals, sintered metals, woods, carbon-based materials, ceramics, and the like. Many ink receiving elements commonly used in ink jet printing can be used. The support for the ink receiving element can be paper or resin-coated paper, plastics such as a polyolefin-type resin or a polyester-type resin such as poly(ethylene terephthalate), polycarbonate resins, polysulfone resins, methacrylic resins, cellophane, acetate plastics, cellulose diacetate, cellulose triacetate, vinyl chloride resins, poly(ethylene naphthalate), polyester diacetate, various glass materials, etc., or an open pore structure such as those made from polyolefins or polyesters. Exemplary papers contemplated for use in the practice of the present invention include ragbond papers, coated papers (e.g., matte papers, semi-gloss papers, clear film papers, high-gloss photographic papers, semi-gloss photographic papers, latex papers, color ink jet papers, presentation papers, and the like), heavy coated papers, opaque bond papers, translucent bond papers, vellum, papers treated for ink, dye or colorant receptivity, and the like. Of course the ink composition is also suitable for printing on any well-known intermediate member for subsequent transfer to a receiver (see U.S. Pat. No. 6,409,331).

Fabrics contemplated for use in the practice of the present invention include any fabric prepared from fibers which (naturally or by post-treatment) contain free hydroxyl and/or free carboxyl groups. Exemplary fibers from which suitable fabrics can be prepared include 100% cotton, cotton/polyester blends, polyesters, silks, rayons, wools, polyamides, nylons, aramids, acrylics, modacrylics, polyolefins, spandex, saran, linens, hemps, jutes, sisals, latexes, butyl rubbers, vinyls, polyamide fibers, aluminum, stainless steel, fabrics treated for ink, dye or colorant receptivity, and the like, as well as combinations of any two or more thereof. The non-absorbing receivers that may be used in the present invention include any receiver that is essentially non-porous. They are usually not specially treated for additional liquid absorption. Therefore, these materials have very low or no liquid absorbing capacity. Examples of such non-absorbing receivers are plastics such as vinyl, polycarbonate, polytetrafluoroethylene (PTFE), polyethylene, polypropylene, polystyrene, cellulose; and other receivers such as ceramics, glass and metals such as aluminum, copper, stainless steel and metallic alloys.

The following examples illustrate the utility of the present invention.

### EXAMPLE 1

Formation of stable drops in an ink jet apparatus using a high percent solids, shear-thinning ink.

### Description of Ink:

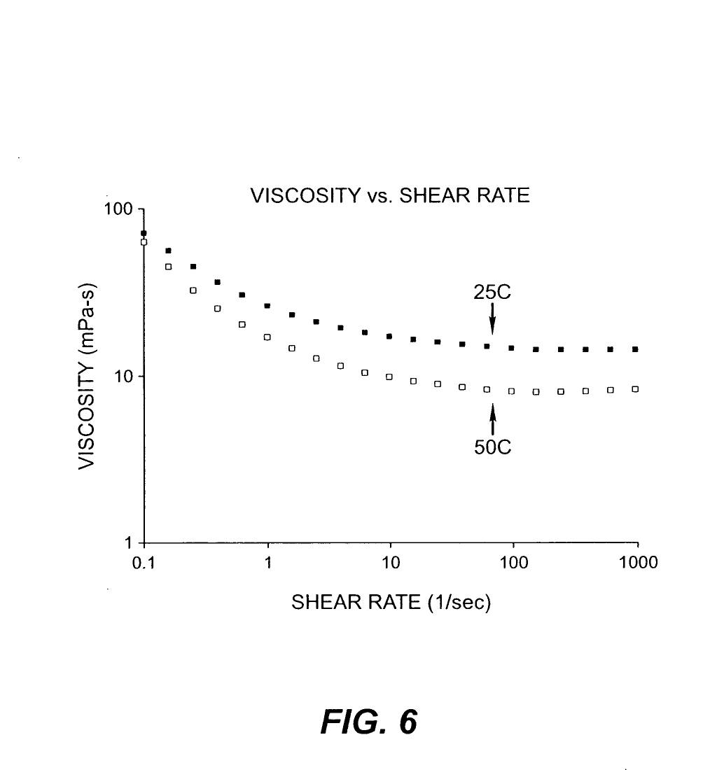

A gravure ink from Flint Group, called Arrowvure 5 Cyan Blue® was used in the jetting experiment. The ink contained 34.44% solids, a surface tension of 31.7 dynes/cm, a pH of 9.46 and a median particle size of 0.105 microns as measured by light scattering using a Microtrac® UPA 150 instrument. The rheology of the ink was measured with an Advanced Rheometric Expansion System (ARES®) rheometer by Rheometric Scientific. This instrument controls strain (rotational velocity in a given geometry) and measures stress (torque). The testing geometry used to analyze the sample was a large Couette (concentric cylindrical bob in cup) with a cup diameter of 34 mm, a bob diameter of 32 mm, a bob length of 33.4 mm, and bob height above cup bottom of 4.0 mm. Steady shear rate sweeps were performed at the desired test temperatures of 25° C. and 50° C. For the 50° C. runs, the sample was rapidly preheated to approximately 50° C. prior to loading into the temperature-equilibrated geometry. To remove any residual structure in the fluid, a pre-shear sweep of 100/s to 400/s was used, with a 3 second delay at each rate followed by a 3 second measurement in both rotational directions. The subsequent rate sweep was performed under the same measurement and delay conditions progressing from 0.1/s to 1,000/s. The auto-range option for the transducer was enabled to change the sensitivity from 10 g-cm to 100 g-cm of torque during the measurement as needed. Table 1 gives the viscosity of the ink equilibrated at 25° C. and 50° C. before testing at shear rates from 0.1/s-1,000/s. The data in Table 1 shows that the ink is shear-thinning at both temperatures. As shown in Table 1, increasing temperature reduces the ink viscosity. This temperature effect can be used in combination with the shear-thinning effect, upon equilibrating the ink, to adjust (control) the desired ink viscosity. The data from Table 1 is graphically represented in FIG. 6.

TABLE 1

| | Viscosity (mPa-s) Ink | Viscosity (mPa-s) Ink |
|---|---|---|
| Shear | in Example 1 | in Example 1 |
| Rate (1/s) | T = 25° C. | T = 50° C. |
| 0.100 | 71.37 | 62.93 |
| 0.158 | 55.77 | 44.95 |
| 0.251 | 44.65 | 32.46 |
| 0.398 | 36.31 | 25.30 |
| 0.631 | 30.44 | 20.31 |
| 1.000 | 26.14 | 17.01 |
| 1.585 | 23.24 | 14.61 |
| 2.512 | 21.08 | 12.74 |
| 3.981 | 19.43 | 11.47 |
| 6.310 | 18.21 | 10.48 |
| 10.00 | 17.26 | 9.849 |
| 15.85 | 16.54 | 9.324 |
| 25.12 | 15.95 | 8.953 |
| 39.81 | 15.41 | 8.587 |
| 63.10 | 15.00 | 8.297 |
| 100.0 | 14.71 | 8.109 |
| 158.0 | 14.47 | 7.995 |
| 251.0 | 14.35 | 8.000 |
| 398.0 | 14.30 | 8.062 |
| 631.0 | 14.34 | 8.187 |
| 1,000.0 | 14.36 | 8.301 |

### Description of Jetting Results of Ink in Example 1:

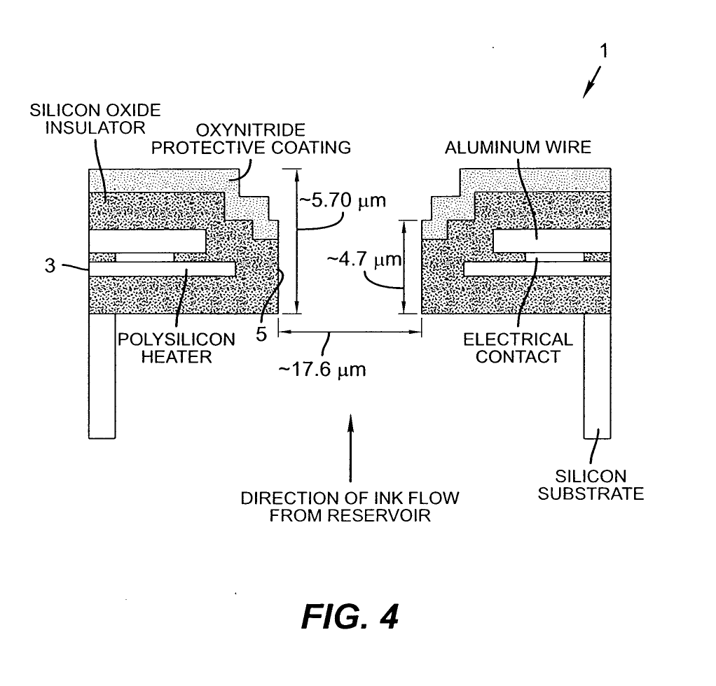

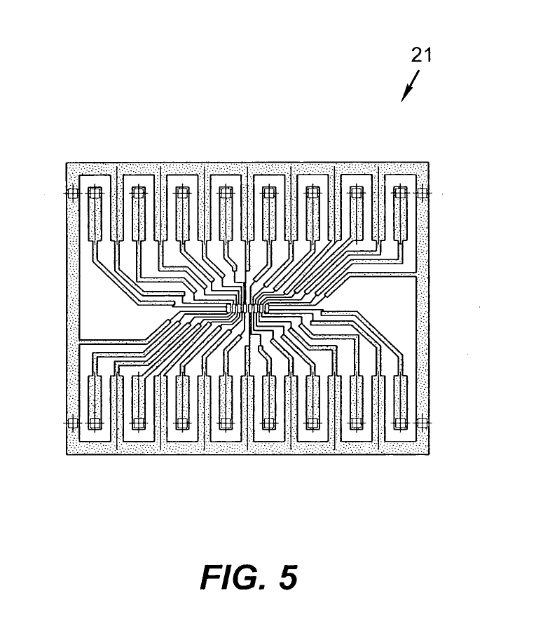

A continuous ink jet apparatus similar to a device utilizing nozzles 1 (one shown) and circuit diagram 21 shown respectively in FIGS. 4 and 5 was used to verify jetting and drop formation of the ink in Example 1 when electrical pulses were applied. FIG. 4 schematically shows an exemplary cross-sectional view of a nozzle 1 for a continuous ink jet apparatus. FIG. 5 shows an exemplary circuit diagram 21 for a continuous ink jet apparatus utilizing the nozzle(s) 1 as shown in FIG. 4. The overall ink jet bead die (not shown) contains eight nozzles at 80 mm spacing. Each nozzle 1 has a split vertical polysilicon heater 3. The nozzle bore 5 has a diameter of 17.6 mm, the polysilicon heater 3 to bore edge is 1.6 mm and the polysilicon heater line width is 2 mm. Each ink jet head die contains nine electrical connections on top and bottom. Eight of these connections are for power and the other for a common ground. The dimensions of the ink channel chips are 40×130 μm² and they are located under their respective nozzles.

The ink was pre-filtered through a 6.0 μm Pall® cylindrical filter before jetting through the ink jet head device. The pressure on supply vessel was set to 35 psi. A Hewlett Packard waveform generator provided heater pulses, and a Fluke Multimeter was used to measure heater resistance. A test stand for the continuous ink jet device was fitted with a camera, strobe, and video system. A strobe light was adjusted to view drops on a video monitor. The frequency was set to 100 KHz with a duty cycle set to 10% (pulse width near 1.0 μm). The voltage pulses were applied to the ink jet head device heaters to form drops and the drop formation from the single nozzle device was observed. With the voltage set to 7.0 volt peak, the vessel pressure was adjusted to 30-70 psi until the straight jets were observed. The voltage, frequency, and pressure were varied to determine the effect of these variables on the device range.

Table 2 shows the effect of frequency on ink drop volume at an operating pressure of 65 psi.

TABLE 2

| Frequency (Hz) | Drop Volume (pL) |
|---|---|
| 50,000 | 84 |
| 100,000 | 42 |
| 150,000 | 28 |
| 200,000 | 21 |

In the jetting test, drops were formed from the fluid when frequencies of 50 kHz, 150 kHz, and 200 kHz were applied. These frequencies provided enough difference in drop size for the ink jet head device to deflect unwanted small drops and to print with the large drops. The velocity of the drops was approximately 15 m/s at 65 psi. Each jet delivered 1.025 g/min. at an operating pressure of 65 psi. The voltage necessary for stable drop formation was 6.8 volts. The jetting test in this Example 1 continued to jet for more than 40 minutes without clogging the nozzles.

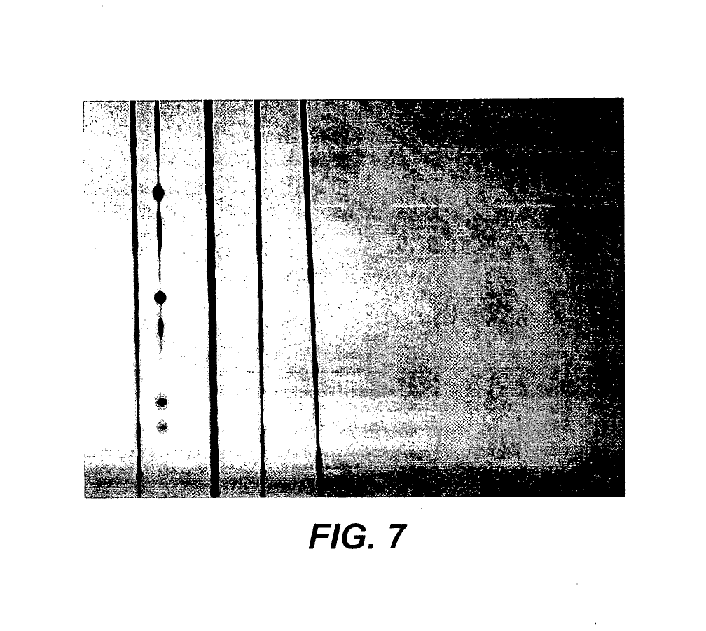

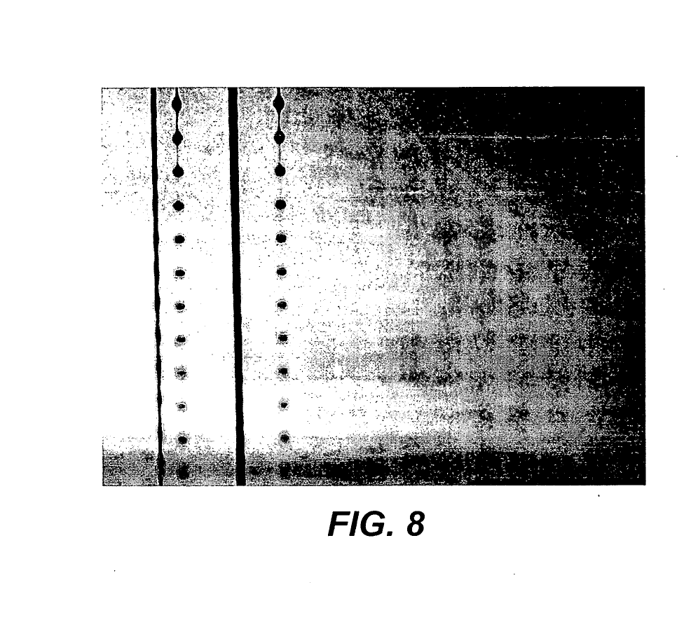

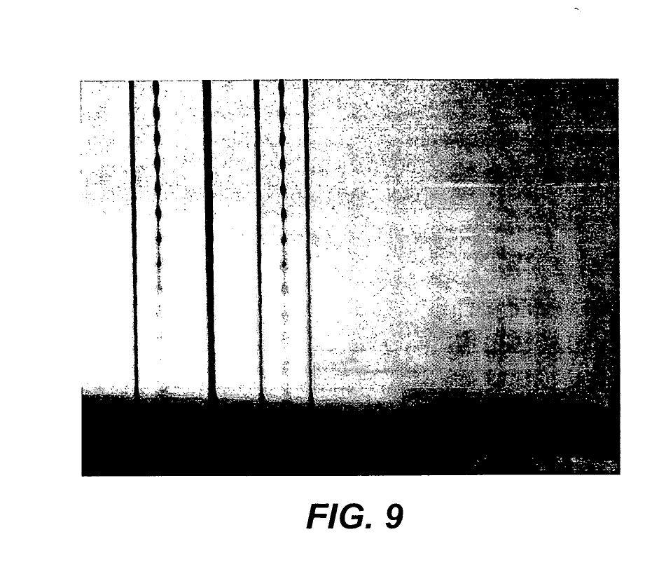

FIG. 7 is a photomicrograph of drop formation of jets formed at an operating pressure of 65 psi, 50 kHz, and 6.7 μs pulse. The calibration factor is 1 mm=73 μm. FIG. 8 is a photomicrograph of drop formation of 2 jets formed at an operating pressure of 65 psi, 150 kHz, and 2.7 μs pulse. The calibration factor is 1 mm=73 μm. FIG. 9 is a photomicrograph of drop formation of 2 jets formed at an operating pressure of 65 psi, 200 kHz and 1.6 μs pulse. The calibration factor is 1 mm=73 μm.

### EXAMPLE 2

Formation of prints on various receivers from an ink jet apparatus using high-percent solids, shear-thinning ink.

The ink used was the same ink as described in Example 1, except 2 wt. % Dapro DF-1760 defoamer (from Elementis Corp.) and 5 wt. % glycerol were added. The final ink contained 30.17 wt. % solids, a surface tension of 32.0 dynes/cm, a pH of 9.38 and a median particle size of 0.0964 microns. Table 3 gives the viscosity of the ink equilibrated at 25° C. at shear rates from 0.1/s-1,000/s. The data in Table 3 show that the ink is shear-thinning at a temperature of 25° C.

TABLE 3

| | Viscosity (mPa-s) |
|---|---|
| | Ink in Example 2 |
| Shear Rate (1/s) | T = 25° C. |
| 0.100 | 18.66 |
| 0.158 | 15.15 |
| 0.251 | 13.61 |
| 0.398 | 12.07 |
| 0.631 | 11.01 |
| 1.000 | 10.24 |
| 1.585 | 9.45 |
| 2.512 | 8.95 |
| 3.981 | 8.53 |
| 6.310 | 8.16 |
| 10.00 | 7.93 |
| 15.85 | 7.74 |
| 25.12 | 7.59 |
| 39.81 | 7.43 |
| 63.10 | 7.33 |
| 100.0 | 7.26 |
| 158.0 | 7.23 |
| 251.0 | 7.27 |
| 398.0 | 7.32 |
| 631.0 | 7.45 |
| 1,000.0 | 7.60 |

The receivers shown in Table 4 were used upon which to print the ink in Example 2:

TABLE 4
Receiver

International Paper Carolina Cover CIS 8 pt. Coated Cardboard
International Paper 50# Dataspeed Laser Mock Plain Paper
PerformancePLUS 998 Clear .020 Gauge Untreated Polypropylene
PerformancePLUS 999 Clear .020 Gauge Untreated Polyethylene

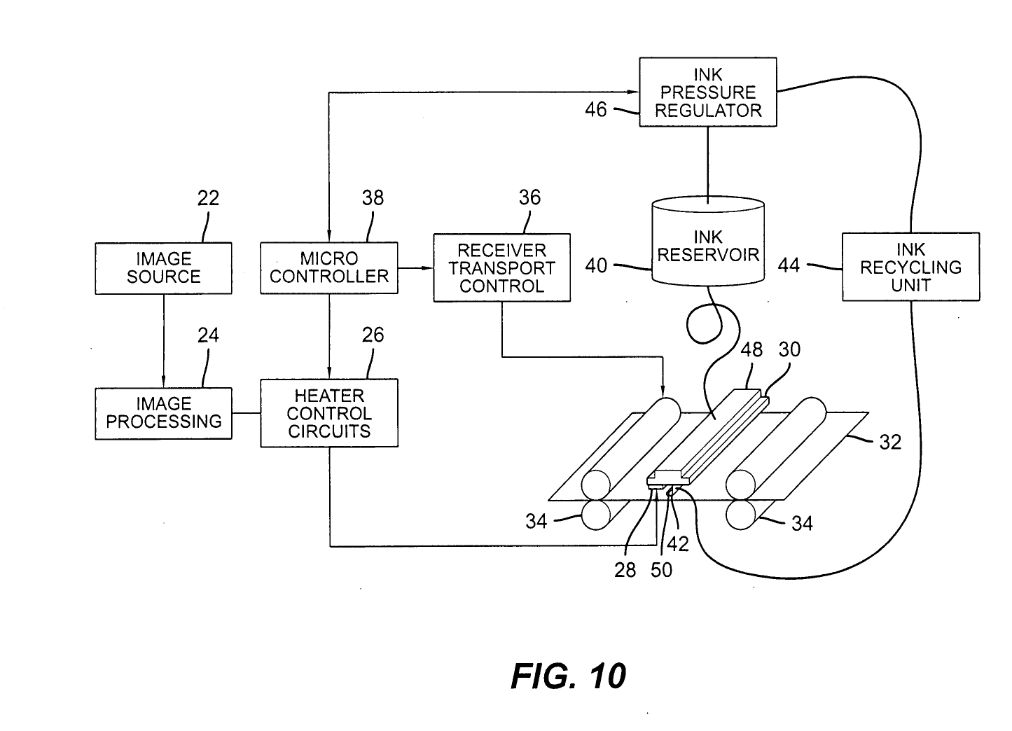

The ink was pre-filtered through a 1.2 μm Pall® cylindrical filter before jetting though the ink jet head device. A continuous ink jet apparatus similar to the device described above, utilizing the printing system with nozzles 52′ and printhead 30, shown in FIGS. 10, 11, and 12 was used to print the ink in Example 2 when electrical pulses are applied. FIG. 10 shows the continuous printing system used to print the ink in Example 2. Referring to FIG. 10, a continuous ink jet printer system includes an image source 22, such as a scanner or computer, which provides raster image data, outline image data in the form of a page description language, or other forms of digital image data. This image data is converted to half-toned bitmap image data by an image-processing unit 24, which also stores the image data in memory. A plurality of heater control circuits 26, read data from the image memory of the image-processing unit 24 and apply time-varying electrical pulses to a set of nozzle heaters 28 that are part of a multi-nozzle printhead 30. These pulses are applied at an appropriate time, and to the appropriate individual nozzles of the printhead 30, so that drops formed from a continuous ink jet stream will form spots on a receiver 32 in the appropriate position designated by the data in the image memory of the image-processing unit 24. Receiver 32 is moved relative to printhead 30 by a suitable transport system 34, which is electronically controlled by a transport control system 36, and which in turn is controlled by a suitable micro-processor based controller 38.

The transport system shown in FIG. 10 is a schematic only, and many different mechanical configurations are of course possible. For example, a transfer roller could be used as a transport system to facilitate transfer of the ink drops to receiver 32. Such transfer roller technology is well known in the art. In the case of page width printheads, it is most convenient to move a receiver past a stationary printhead. However, in the case of scanning print systems, it is usually most convenient to move the printhead along one axis (the sub-scanning direction) and the receiver along an orthogonal axis (the main scanning direction) in a relative raster motion.

Ink is contained in an ink reservoir 40 under pressure. In the non-printing state, continuous ink jet drop streams are unable to reach receiver 32 due to an ink gutter 42 that blocks the stream and which may allow at least a portion of the ink to be recycled by an ink-recycling unit 44. The ink-recycling unit 44 reconditions the ink and feeds it back to ink reservoir 40. Such ink recycling units 44 are well known in the art.

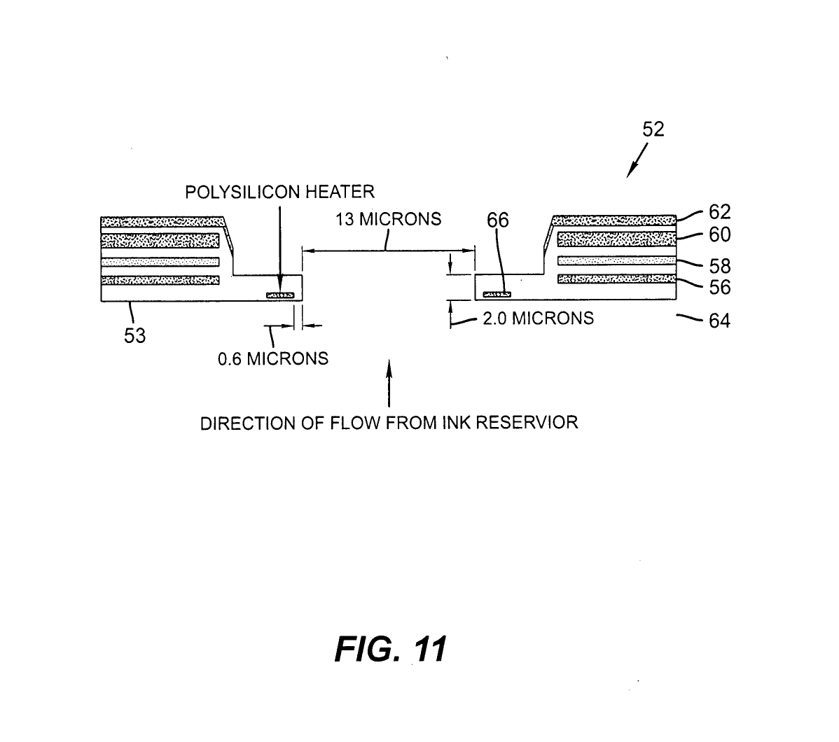

The ink pressure suitable for optimal operation will depend on a number of factors, including geometry and thermal properties of the nozzles and thermal properties of the ink. A constant ink pressure can be achieved by applying pressure to ink reservoir 40 under the control of ink pressure regulator 46. The ink is distributed to the back surface of printhead 30 by an ink channel device 48. The ink preferably flows through slots and/or holes etched through a silicon receiver of printhead 30 to its front surface, where a plurality of nozzles and heaters (such as one shown in FIG. 4 or 11) are situated. With printhead 30 fabricated from silicon, it is possible to integrate heater control circuits 26 with the printhead. An ink drop deflection system 50, described in more detail below, is positioned proximate printhead 30.

FIG. 11 schematically shows an exemplary cross-sectional view of the nozzle for the continuous ink jet apparatus printhead 30 of FIG. 10, designated generally by the numeral 52. The nozzle 52 includes a silicon dioxide insulator 54, electrical contacts metal 56, metal 58, and metal 60 in silicon nitride protective coating 62 on a silicon receiver 64. Each nozzle 52 contains a circular polysilicon heater 66. The bore diameter of the nozzle 52 is 13 microns, the circular polysilicon heater 66 width is 2 microns, and the distance between the polysilicon heater 66 and bore edge is 0.6 microns.

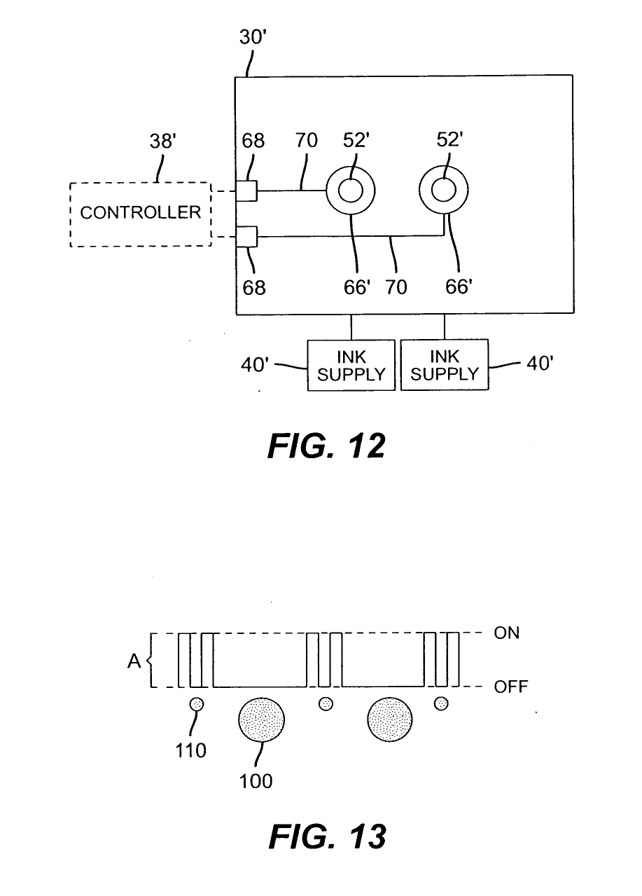

FIG. 12 schematically shows an exemplary printhead 30′, which contains thirty-two nozzles 52′ (two shown), generally of the type described above with reference to FIG. 11. Referring to FIG. 12, an ink droplet forming mechanism of a preferred embodiment of the present invention is shown, including a printhead 30′, at least one ink supply 40′ (two shown), and a controller 38′. Although the ink droplet forming mechanism is illustrated schematically and not to scale for the sake of clarity, one of ordinary skill in the art will be able to readily determine the specific size and interconnections of the elements of the preferred embodiment. Printhead 30′ is formed from a semiconductor material (silicon, etc.) using known semiconductor fabrication techniques (CMOS circuit fabrication techniques, micro electromechanical structure (MEMS) fabrication techniques, etc.). However, it is specifically contemplated and, therefore, within the scope of this disclosure, that printhead 30′ may be formed from any materials using any fabrication techniques conventionally known in the art.

At least one nozzle 52′ (two shown in FIG. 12) is formed on printhead 30′. Nozzle 52′ is in fluid communication with ink supply 40′ through an ink passage (not shown) also formed in printhead 30′. In a preferred embodiment, printhead 30′ has two ink supplies in fluid communication with two nozzles, respectively. Each ink supply may contain a different color ink for color printing. However, it is specifically contemplated, and therefore within the scope of this disclosure, that printhead 30′ may incorporate additional ink supplies and corresponding nozzles in order to provide color printing using three or more ink colors. Additionally, black and white or single color printing may be accomplished using a single ink supply and single nozzle.

A heater 66′ is at least partially formed, or positioned, on printhead 30′ around a corresponding nozzle 52′. Although heater 66′ may be disposed radially away from an edge of the corresponding nozzle, the heater is preferably disposed close to edge of corresponding nozzle in a concentric manner. In a preferred embodiment, heater 66′ is formed in a substantially circular or ring shape. However, it is specifically contemplated, and therefore within the scope of this disclosure, that heater 66′ may be formed in a partial ring, square, or other suitable shape. Heater 66′ includes an electric resistive heating element electrically connected to contact 68 via conductor 70. Conductor 70 and contact 68 may be at least partially formed or positioned on printhead 30′ and provide an electrical connection between controller 38′ and heater 66′. Alternatively, the electrical connection between controller 38′ and heater 66′ may be accomplished in any well-known manner. Additionally, controller 38′ may be a relatively simple device (a power supply for heaters, for example) or a relatively complex device (logic controller, programmable microprocessor, for example) operable to control many components in a desired manner.

Referring to FIG. 13, an example of the activation frequency provided by controller 38′ to heater 66′ (shown generally as trace A) of FIG. 12, and the resulting individual ink droplets 100 and 110 are shown. A high frequency of activation of heater 66′ results in small volume droplets 110, and a low frequency of activation of heater 66′ results in large volume droplets 100. Activation of heater 66′ may be controlled independently based on the ink color required and ejected through corresponding nozzle 52′, movement of printhead 30′ relative to a print media receiver 32 (FIG. 10), and/or an image to be printed. It is specifically contemplated, and therefore within the scope of this disclosure, that a plurality of droplets may be created having a plurality of volumes, including a mid-range activation frequency of heater 66′ resulting in a medium volume droplet (between droplets 100 and 110). As such, reference below to large volume droplets 100 and small volume droplets 110 is for example purposes only and should not be interpreted as being limiting in any manner.

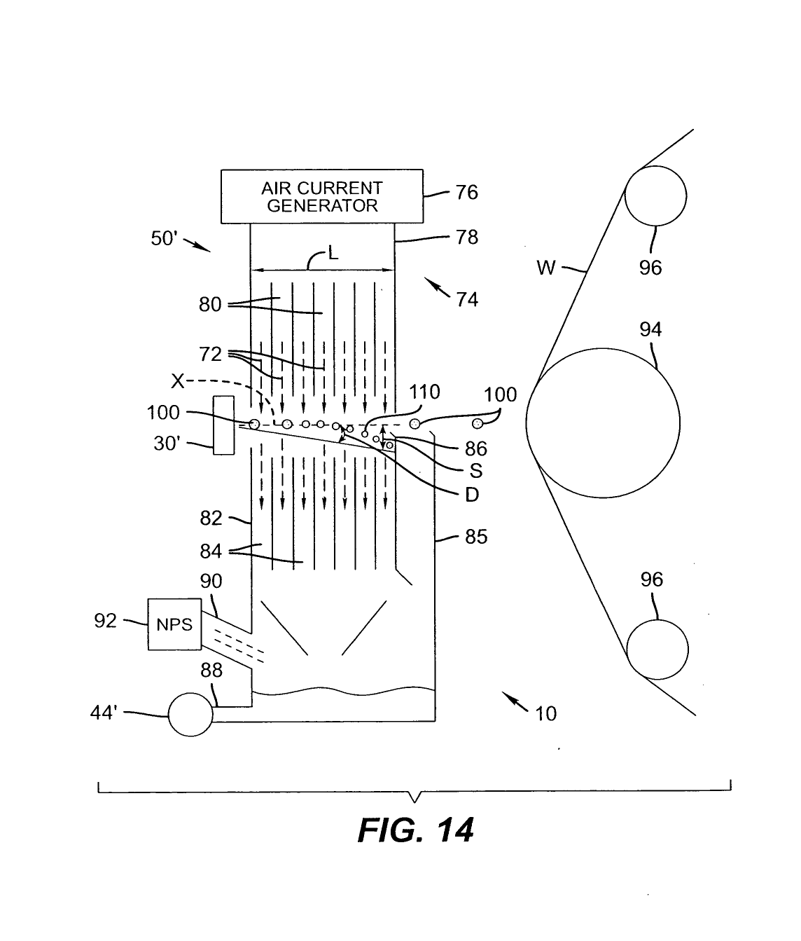

FIG. 14 schematically shows an exemplary ink jet printer apparatus used to print the ink according to this invention. Large volume ink droplets 100 and small volume ink droplets 110 are ejected from ink droplet forming mechanism printhead 30′ substantially along ejection path X in a stream. A droplet deflector system 50′ applies a force (shown generally at 72) to ink droplets 100, 110 as ink droplets 100, 110 travel along path X. Force 72 interacts with ink droplets 100, 110 along path X, causing the ink droplets 100, 110 to alter course. As ink droplets 100, 110 have different volumes and masses, force 72 causes small droplets 110 to separate from large droplets 100 with small droplets 110 diverging from path X along deflection angle D. While large droplets 100 can be slightly affected by force 72, large droplets 100 remain traveling substantially along path X. Droplet deflector system 50′ can include a gas source 74 that provides force 72. Typically, force 72 is positioned at an angle with respect to the stream of ink droplets operable to selectively deflect ink droplets depending on ink droplet volume. Ink droplets having a smaller volume are deflected more than ink droplets having a larger volume.

Gas source 74 of droplet deflector system 50′ includes a gas pressure generator 76 coupled to a plenum 78 having at least one baffle 80 (a plurality shown) to facilitate laminar flow of gas through plenum 78. An end of plenum 78 is positioned proximate path X. A recovery plenum 82 is disposed opposite plenum 78 and includes at least one baffle 84 (a plurality shown). Additionally, baffle 84 includes catcher surface 86 defined on a surface thereof proximate path X. Alternatively, a surface of recovery plenum 82 may define a catcher surface thereon. An ink recovery conduit 88 communicates with recovery plenum 82 to facilitate recovery of non-printed ink droplets by an ink recycling unit 44′ for subsequent use. Additionally, a vacuum conduit 90, coupled to a negative pressure source 92, can communicate with recovery plenum 82 to create a negative pressure in recovery plenum 82, improving ink droplet separation and ink droplet removal. In operation, a print media W (receiver), or intermediate image-receiving web, is transported in a direction transverse to path X by a drive roller 94 and idle rollers 96 in a known manner. Transport of print media W is coordinated with operation printhead 30′ to produce a desired image thereon. This can be accomplished using controller 38′ (FIG. 12 for example) in any suitable known manner.

The ink in this example was printed with the above described ink jet printing apparatus on each of the four receivers described in Table 4. After printing, all receivers contained images that exhibited excellent adhesion, excellent durability to dry, rub resistance, and excellent image quality.

The invention has been described in detail with particular reference to certain preferred embodiments thereof, but it will be understood that variations and modifications can be effected within the spirit and scope of the invention.

### PARTS LIST

1 Nozzle
3 Polysilicon heater
5 Nozzle bore
21 Circuit diagram
22 Image source
24 Image-processing unit
26 Heater control circuits
28 Nozzle heater
30, 30′ Printhead
32 Receiver
34 Transport system
36 Transport control system (see FIG. 1)
38 Micro-controller
38′ Controller
40 Ink reservoir
40′ Ink supply
42 Ink gutter
44, 44′ Ink recycling unit
46 Ink pressure regulator
48 Ink channel device
50 Ink drop deflection system
52, 52′ Nozzle
54 Silicon dioxide insulator
56 Metal
58 Metal
60 Metal
62 Silicon nitride protective coating
64 Silicon receiver
66 Polysilicon heater
66′ Heater
68 Contact
70 Conductor
72 Force
74 Gas source
76 Gas pressure generator
78 Plenum
80 Baffle
82 Recovery plenum
84 Baffle
86 Catcher surface
88 Ink recovery conduit
90 Vacuum conduit
92 Negative pressure source
94 Drive roller
96 Idle rollers
100 Large volume ink droplets
110 Small volume ink droplets
A Trace
D Deflection angle
W Print media
X Path

What is claimed is:

1. In an ink jet printing apparatus for high speed/high quality printing, an ink jet ink comprising:
a high concentration of solids in the range of about 20-70 wt. %, and exhibiting shear-thinning characteristics.

2. The ink jet ink according to claim 1, wherein such ink has a viscosity between 50 and 200 mPa-s, at a shear rate of about 0.1/s, and a viscosity less than 20 mPa-s at a shear rate of about 1,000/s.

3. The ink jet ink according to claim 1, wherein such ink has high solids concentration in the range of about 30-40 wt. %, a viscosity between 30 and 100 mPa-s, at a shear rate of about 0.1/s, and a viscosity less than 10 mPa-s, at a shear rate of about 1,000/s.

4. The ink jet ink according to claim 1, wherein the ink is utilized in an apparatus including a continuous ink jet printhead.

5. The ink jet ink according to claim 1, wherein the ink is utilized in an apparatus including a drop-on-demand ink jet printhead.

6. The ink jet ink according to claim 1, wherein the ink includes shear-thinning aqueous based inks using pigments or dyes as the colorant.

7. The ink jet ink according to claim 1, wherein the ink includes shear-thinning solvent based inks using pigments or dyes as the colorant.

8. The ink jet ink according to claim 1, wherein the ink includes shear-thinning UV curable inks.

9. The ink jet ink according to claim 1, wherein the equilibrium ink temperature is controlled to adjust ink viscosity.

10. The ink jet ink according to claim 1, wherein shear-thinning of the ink is accomplished by a continuous ink flow within the printhead device.

11. The ink jet ink according to claim 1, wherein shear-thinning of the ink is accomplished by ultrasonic agitation within the printhead device.
